(19) United States
(12) Patent Application Publication
(10) Pub. No.: US 2011/0100227 A1
(43) Pub. Date: May 5, 2011

(54) DEVICE FOR HEATING A CUP-SHAPED RECEPTACLE

(76) Inventors: Christophe S. Boussemart, Lugrin (FR); Fabien Ludovic Agon, Le Bouveret (CH)

(21) Appl. No.: 12/996,763

(22) PCT Filed: Jun. 24, 2009
(86) PCT No.: PCT/EP09/57856

§ 371 Date: Dec. 7, 2010

(30) Foreign Application Priority Data
Jun. 26, 2008 (EP) 08159079.6

(51) Int. Cl. A23L 2/00

(52) U.S. Cl. 99/275; 392/418

(57) ABSTRACT

A heating device for cup-shaped receptacles such as coffee cups. The device includes a support for supporting a receptacle with the support including a heating mechanism and being designed to generate and guide heated air or radiating heat to the receptacles in order to heat a surface of the receptacle. The surface is preferably the whole inner or outer surface of the cup-shaped receptacle.

### FIELD OF THE INVENTION

The present invention relates to a device for heating a receptacle such as a coffee or tea cup. In particular, the invention relates to an enhanced warming or heating of a receptacle prior to or during the filling or dispensing of a beverage to the receptacle.

### BACKGROUND OF THE INVENTION

It has been found that a warm or hot beverage such as a coffee or tea is looses up to 12° C. during five minutes within a cold receptacle due to the heat exchange with the cold environment. Therefore, devices for heating receptacles such as coffee or tea cups have been developed in order to heat such a receptacle prior to the filling with the warm or hot beverage. According to this, the heat exchange which takes place between the receptacle and the beverage does not lead to a fast cooling of the beverage within the receptacle. Therefore, the beverage can be kept at the desired temperature for a longer time.

A conventional means for heating receptacles is the provision of hot steam to the receptacle which is usually provided by a steam generator of a coffee machine. Usually, a duct provided at the heating means enables a cone-shaped broadening of a steam jet such that a larger surface of the receptacle can be provided with steam and thus, heating of the receptacle is enhanced.

However, for this approach to heat a receptacle, a steam generator is specifically needed for providing steam to the receptacle. Thereby, an operator has to wait a certain time until the steam generator has heated up in order to effectively provide steam to the receptacle. Moreover, the heating of a receptacle by means of steam suffers the inconvenience that the steam condenses at the surface of the receptacle to form water and thus, an operator has two empty the receptacle prior to the provision of the beverage thereto.

Another way of heating the receptacle prior to the provision of a beverage thereto is by means of a cup warmer which is usually arranged at a top surface of a beverage production machine. Thereby, a conduct of layers such as a metal as formed at the top surface and the receptacle is placed thereon. Hence, one or more receptacles can be effectively heated by conductance and heat radiation dependent on the dimensions of the conductive layer by placing the receptacles thereon.

However, these means for heating the receptacles suffer the inconvenience that since only a predefined line or ring-shaped contact is established between the conductive layer and the receptacle, heating of the receptacle takes very long time.

DE 34 37 905 A1 reveals a device for preheating crockery, having a plurality of receptacles and standing areas which can be rotated about an axis for stacks of crockery, and having a heater, consists mainly of a base support with a stand placed rotatably thereon which has at its upper end an end plate which bears the receptacles and, at its lower end, a baseplate which forms the base for the standing areas.

Based on the cited prior art, the present invention aims at providing heating means for a receptacle which enable a fast and effective heating thereof. Accordingly, a convenient heating of the receptacle prior to the filling of a warm or hot beverage thereto is obtainable and the temperature of the beverage can be maintained for a longer time.

The present invention seeks to address the above described problems. The invention also aims at other objects and particularly the solution of other problems as will appear in the rest of the present description.

### OBJECT AND SUMMARY OF THE INVENTION

In a first aspect, the present invention relates to a heating device for cup-shaped receptacles such as e.g. coffee cups or glasses, said device comprising support means for supporting a receptacle, said support means comprise heating means which are designed to generate and guide to the receptacles heated air or radiating heat in order to heat a surface of the receptacle, wherein said surface is preferably the whole inner and/or outer surface of the cup-shaped receptacle.

With the device according to the present invention, the fast and effective heating of a cup-shaped receptacle is enabled. According to this, a beverage which is supplied to the receptacle can be kept at a desired warm or hot temperature for a longer time, compared to the case when an unheated cup is used. Thereby, the device can be used for the warming or heating of any kind of receptacles such as receptacles made e.g. from porcelain or glass.

The support of the device is preferably designed to support a bottom part of the receptacle. However, the support means may be designed to support a lateral part of the receptacle such as a handle or edge of a receptacle.

Due to the fact that the heating means of the device are designed to generate and guide heated air or radiating heat to preferably the whole inner and/or outer surface of the cup-shaped receptacle, and more efficient and quicker heating of the receptacle is enabled.

The heating means preferably comprise a heating component integrated in the support of the device which is designed to provide heat or radiating heat to the receptacle.

In a preferred embodiment the heating component is a halogen lamp suitable for effectively heating a dedicated receptacle. Preferably, the halogen lamp has a power of about 250 Watts. Moreover, the heating component may be any other heat source which emits heated air or radiating heat. The heating component may as well provide steam to the receptacle.

Furthermore, heating of the receptacle may as well be obtained by providing a heated liquid or gas to the receptacle.

It should be noted that the heat transfer between the heating component and the receptacles to be heated may take place due to heat conductance and/or heat radiation and/or convection.

In a preferred embodiment, the heating component is connected to a switchable circuit which comprises detection means designed to enable a detection of a receptacle placed on the support means. Accordingly, the heating device is enabled to detect a presence of a receptacle situated on the support means. Thereby, the switchable circuit is preferably designed to activate the heating component for a predefined period of time when a receptacle is placed onto the support. Accordingly, automatic heating of the receptacle is enabled in case a receptacle is detected by the detection means. Moreover, due to the described arrangement excessive energy loss can be prevented as the heating component is only activated in case a receptacle to be heated is detected.

Preferably, the period of time in which the heating component is activated can be adjusted by an operator. Therefore, dedicated adjustment means are preferably provided such as a regulating switch which can be operated by a user of the heating device.

Furthermore, temperature controlling means such as a temperature sensor may be provided at the device for measuring the current temperature of the receptacle to be heated and/or the heat emitted by the heating means. Hence, a monitoring of the current temperature of the receptacle to be heated is enabled. Hence, a user may for example choose a target temperature of the receptacle such that the heating component is automatically activated when the predefined target temperature is reached.

In a preferred embodiment, the detection means and the switchable circuit are integrated in the support of the device. According to this, a space saving and compact arrangement of the heating device is obtained. Thereby, the detection means may be a proximity sensor or a weight sensor being integrated in the support means of the device. However, it should be noted that any other sensor or means may be used for determining whether a receptacle is placed onto the support means.

Preferably, the heating means further comprise air generating means which are designed for providing a stream of air towards the heating component of the device. In a preferred embodiment, the air generating means comprise at least one ventilator suitable for generating a stream of air. According to this, the heated air or radiating heat which is emitted by the heating component can be effectively transported by said generated stream of air towards a receptacle to be heated.

Moreover, the heating means preferably comprise guiding means for guiding the heated air or radiating heat towards an inner and/or outer surface of the receptacle. Hence, a radiating heat emitted by the heating component is effectively guided to the receptacle to be heated and thus, heat or energy loss is suppressed. Thereby, the guiding means are preferably designed such that absorption of heat energy by the guiding means is minimized. Therefore, the guiding means are preferably coated by a dedicated material suitable to reflect heat radiation such that the energy loss to the outside of the guiding means is effectively suppressed.

Furthermore, an outlet of the guiding means is preferably arranged such that heated air or radiating heat guided by said guiding means is directed directly to the inner and/or outer surface of the cup-shaped receptacle. Thereby, the outlet of the guiding means may comprise at least one aperture or duct through which the heated air or radiating heat can be transmitted to the surface of the receptacle. The aperture of the guiding means may as well comprise a plurality of small sized apertures or ducts. Thereby, the size of the apertures and their geometric form may vary in order to provide a specific amount of heat to particular predefined regions or areas of the inner and/or outer surface of the receptacle.

In a preferred embodiment, the device further comprises retractable enclosing means which can be connected to the guiding means and which are designed to selectively enclose a receptacle.

According to this, heated air or radiating heat which exits the guiding means at the corresponding opening or apertures is enclosed between the receptacle and the enclosing means such that an effective and fast heating of the receptacle is enabled.

The enclosing means are designed such that there is a preferred space between 2 and 3 mm between the inner or outer surface of the receptacle and the retractable enclosing means.

The retractable enclosing means are preferably made of a conductive material such as a metal to further enhance the heating of the receptacle. Thereby, the enclosing means preferably comprise holding means such that a human operator can handle the retractable enclosing means without burning his or her fingers.

In a preferred embodiment, the retractable enclosing means further comprise adjustment means such that the width and diameter of the enclosing means can be adapted to receptacles of variable geometric dimensions. According to this, a broad application spectrum of the heating device is enabled, since the enclosing means are not restricted to be used with certain receptacles of predefined geometric measures only.

In a preferred embodiment, the support means of the device may be designed to support a plurality of stacked receptacles. According to this, a plurality of receptacles which are placed adjacent to each other can be housed by said support means.

Moreover, the support means preferably comprise release means for selectively releasing at least one of the receptacles from the receptacles stack and thus, for releasing at least one of the receptacles from the support means.

The release means are preferably mechanical means interacting with the bottom or the handle of the receptacle which can be operated such that at least one of the receptacles from the receptacle stack can be selectively released from the support means.

In this embodiment, the guiding means are preferably designed such that at least one of the plurality of stacked receptacles is provided with heated air or radiating heat. Hence, at least one of the receptacles supported by the support means can be effectively heated at a predefined position within the support means to which heated air or radiating heat is guided by the guiding means. Thereby, the guiding means are preferably designed such that at least the receptacle which is to be released first from the stacked receptacles by the release means is heated. Moreover, the guiding means may as well be designed such that a plurality of stacked receptacles is heated at the same time.

In a second aspect, the present invention relates to a capsule based beverage production device for preparing a beverage from a food substance contained in a capsule by injection of a liquid into the capsule, wherein said liquid is provided by a pump, said device comprising a liquid supply which is in fluid connection with the pump, a control unit for controlling at least the pump of the device, a support for placing a receptacle thereon, wherein said support is arranged below the liquid outlet of the device, the device further comprising heating means which are designed to provide heated air or radiating heat to an inner or outer surface of a receptacle placed on the support of the device.

With the device according to this invention, it is possible to provide a liquid to portioned ingredients housed within a capsule provided to the device and to hence enable an interaction of the ingredients and the heated and pressurized liquid to form a liquid comestible, for example a soup or a beverage. Thereby, the heating means of the device enable the heating of a receptacle which is placed on the support of the device such that the temperature of the beverage or soup to be delivered to the receptacle is maintained at a desired high temperature for a long time.

WO 03/059778 relates to such a capsule which is preferably used for beverage preparation with the present device. The capsule is preferably a sealed capsule having a body of inox material such as aluminium and contains one or more ingredients. After the injection of liquid into the capsule, the pouring from the capsule may be delayed in order to provide sufficient time for the interaction of the liquid and the ingredients contained within the capsule. For the pouring of the beverage to be prepared from the capsule, opening means such as relieves against an outlet membrane which open a lower wall of the capsule may be provided. These opening means interact with the pressure rise within the capsule when the liquid is injected. The capsule has among others the advantage that beverages can be prepared without a “cross contamination” i.e. that a first beverage to be prepared does not transmit one or more undesired characteristics such as taste, colour and/or odour to a second beverage distributed after the first.

In a preferred embodiment, the control unit of the device is designed for controlling the heating means of the device such that the heating means are operated prior to and during to the beverage preparation. According to this, heating of the receptacle is obtained prior to and during the delivery of the beverage to the receptacle. Hence, the preparation of the beverage and the heating of the receptacle are coordinated such that the waiting time for a human operator who intends to prepare a warm or hot beverage in a heated receptacle is minimized.

Thereby, the warming or heating of the receptacle by the heating means is controlled to take place during the coffee extraction from the capsule. Accordingly, the blind time, e.g. the time in which no beverage is delivered from the outlet of the device, can be used for heating the cup prior to the filling of liquid thereto.

### BRIEF DESCRIPTION OF THE DRAWINGS

Further features, advantages and objects of the present invention will become apparent for a skilled person when reading the following detailed description of embodiments of the present invention, when taking in conjunction with the figures of the enclosed drawings.

FIGS. 1a and 1b show a preferred embodiment of a heating device according to the present invention in sectional side view.

FIG. 1c shows another preferred embodiment of a heating device according to the present invention in which a steam generator is provided for heating the receptacle.

FIG. 2a shows a front and a side view of another preferred embodiment of the heating device according to the present invention, wherein the support means are designed to support a plurality of stacked receptacles.

FIG. 2b shows a sectional side view of the stacked receptacles to be used with the embodiment of the invention according to FIG. 2a.

FIG. 2c shows a sectional side view of section A of the support means shown in FIG. 2a.

FIGS. 3a-3c relate to a front view of the device according to the embodiment shown in FIGS. 2a and 2b, wherein the support means comprise release means for selectively releasing the stacked receptacles from the support means.

FIGS. 4a-4c relate to a front view of the device according to the embodiment shown in FIGS. 2a and 2b being equipped with another preferred embodiment of the mechanical release means.

FIG. 5 shows a sectional side view of a preferred embodiment of a capsule based beverage production device according to the present invention which comprises heating means.

FIG. 6 shows a perspective sectional side view of the guiding means and the retractable enclosing means according to the present invention.

### DETAILED DESCRIPTION OF EMBODIMENTS

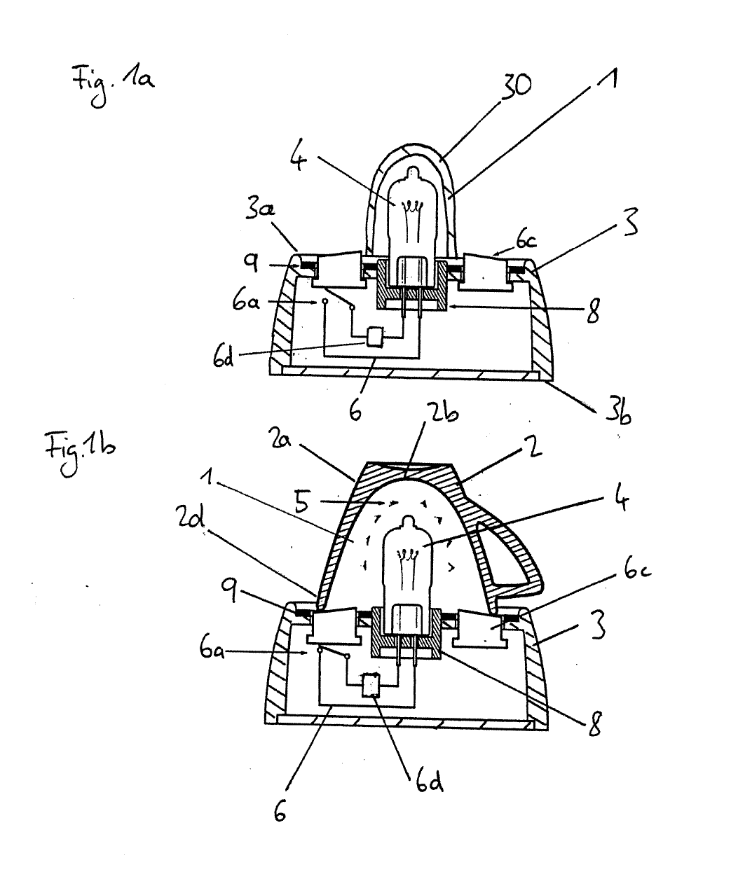

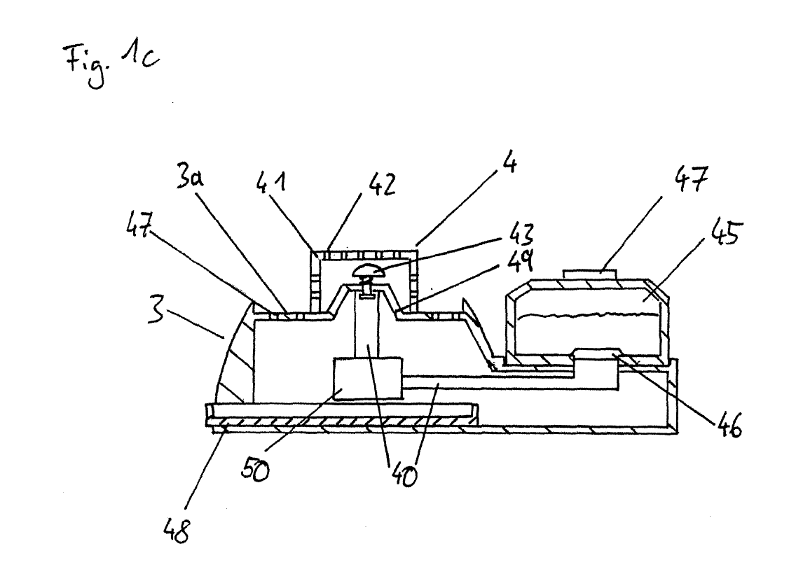

FIG. 1a and 1b show a preferred embodiment of a heating device according to the present invention in sectional side view.

As shown in FIG. 1a, the heating device comprises a support 3 on which a receptacle 2 can be placed. The support 3 is preferably of rectangular or round shape. The support 3 is preferably made of a non-conductive material such as plastics or porcelain. Accordingly, heating of the support 3 during operation of the heating device is suppressed which enables a convenient usage of the device, since a user can be prevented from burning his or her fingers when touching the support 3.

The support 3 comprises a lower surface 3b on which the support is placed and an upper surface 3a which provides sufficient space for placing a receptacle such as a coffee or tea cup thereon.

The lower surface 3b may be equipped with standing means such as rubber strips which enable a safe and secure positioning of the device during operation thereof.

The upper surface 3a is preferably equipped with an additional layer or coating 9 which enforces the friction between the support 3 and the receptacle to be placed on the support in order to enable a safe and secure positioning of the receptacle 2 on the support 3.

Furthermore, the upper surface 3a may be provided with grooves or apertures (not shown) which are designed to guide any moisture or liquid from the upper surface 3a to the circumferential surface of the support 3. It may as well be possible to provide a drip tray (not shown) which is in fluid connection with said grooves or apertures. According to this, any remaining moisture or liquid which is left within the receptacle 2 and which is transferred to the upper surface 3a of the support 3 by placing the receptacle 2 onto the support 3 can be effectively removed from the upper surface 3a and guided to the circumferential surface of the support or to the drip tray by means of the provided grooves or apertures.

At the upper surface 3a a heating component 4 is arranged which protrudes from said surface 3a to a predefined extent. Preferably, the heating component 4 is arranged centrically on the upper surface 3a of the support 3. As shown in FIG. 1a, the heating component 4 is preferably a halogen lamp.

Moreover, the support 3 comprises mounting means 8 such as a socket for mounting said heating means 4 thereon.

The measures of the halogen lamp 4 are preferably chosen such that a receptacle 2 can be placed upside down on the surface 3a of the support 3, as shown in FIG. 1b.

At the upper surface 3a of the support 3 protecting means 30 are preferably disposed which are arranged to protect the heating component 4 protruding from said upper surface 3a. Thereby, the protection means 30 are preferably cone-shaped and comprise a multitude of horizontal or vertical slots or apertures such that heat emitted by the heating component 4 can be effectively provided to the circumference thereof. Preferably, the protection means 30 are made of a conductive material such as metal in order to further enhance the heat emission of the heating component 4 to the circumference thereof. Furthermore, the protection means 30 are preferably connected to the upper surface 3a in a releasable manner. Accordingly, the maintenance properties of the device can be enhanced and thus, the maintenance and exchange of the heating component 4 is facilitated.

In another preferred embodiment, the protecting means 30 is a cover made of glass such that the radiating heat emitted by the heating component 4 can be distributed to the circumference thereof. According to this, the heating component 4 is fully covered by said protecting means 30 made of glass and hence, the heating component 4 can be effectively protected from humidity or moisture, since no grooves or apertures are provided within the cover 30. In addition, a human operator can be prevented from being burned by the heating component 4.

Furthermore, the support 3 preferably comprises a switchable circuit 6 which is connected to the heating means 4. Thereby, the switchable circuit 6 is preferably connected to a power supply (not shown). Thereby, the power supply can be any means for providing energy such as a battery or a connection to the mains supply.

In addition, the support 3 comprises detection means 6c which are preferably arranged at the upper surface 3a of the support 3. The detection means 6c may comprise at least one sensor such as a proximity sensor or weight sensor suitable for detecting a presence of a receptacle situated on the upper surface 3a of the support 3. Thereby, the detecting means 6c are connected to the switchable circuit 6 by means of a switch 6a.

As shown in FIG. 1b, in case a receptacle 2 is placed upside down on the upper surface 3a of the support 3, the switchable circuit 6 is closed by means of the switch 6a due to the detection means 6c. In the shown embodiment, the detection means 6c are four sensor bottoms which close the switchable circuit 6 when being pushed down due to the weight of a receptacle 2 to be placed thereon. Thereby, the bottoms 6c are arranged at equal distance to each other and around a central axis of the support 3. Thereby, the switchable circuit 6 preferably activates the heating component 4 in case all four of the detecting sensors 6c are pushed down. Hence, the heating component 4 is only activated in case a receptacle 2 is placed on the upper surface 3a of the support 3 and accordingly, unintended activation of the heating component 4 by means of pressing down only one of the detection sensors 6c is prevented.

In a preferred embodiment, the heating component 4 is designed to provide radiating heat of about 45 to 55 degrees to the inner surface 2b of the receptacle 2 as indicated by arrows 5 in FIG. 1b. Moreover, the mounting device 8 of the heating component 4 is preferably protruding to a certain extend from the center of the upper surface 3a of the support 3. Consequently, the halogen lamp 4 is mounted at a certain extent above the upper surface 3a. According to this, an upper rim portion 2d of the receptacle 2 during heating of the receptacle 2 is located such that the radiating heat does not fully reach said upper rim portion 2d. Hence, the radiating heat 5 heats the inner surface 2b of the receptacle 2 to a greater extent than the upper rim portion 2d thereof. Accordingly, a selective application of radiation heat to the receptacle 2 is obtained. Thus, a human operator is prevented from burning his or her lips when drinking from the heated receptacle 2.

In addition due to the switchable circuit 6 and the fact that the halogen lamp 4 is only activated in case the receptacle 2 is placed onto the support 3, blinding of a human operator due to the light emission of the halogen lamp 4 is effectively prevented.

In a preferred embodiment, the switchable circuit 6 comprises time adjustment means for controlling the time during which the heat component 4 is activated in case a receptacle 2 is placed on the support 3. Accordingly, a user may set the predefined time for heating the receptacle 2 and thus, for reaching a desired temperature of the receptacle. Preferably, the heating component 4 is designed to provide a desired temperature of 45 to 55° to the receptacle 2 during a preferred heating time of approximately 10 seconds. Hence, a convenient heating of the receptacle 2 is possible prior to filling the receptacle 2 with a warm or hot beverage.

FIG. 1c shows a sectional side view of another preferred embodiment of the present invention. Thereby, instead of a halogen lamp, the heating means 1 comprise a steam generator 48 for heating the receptacle 2.

In this embodiment, the support 3 comprises the steam generator 48 connected to a liquid supply means 40 and an outlet duct 43. The outlet duct 43 is preferably arranged in a central protruding base 49 protruding from the upper surface 3a of the support 3. Moreover, the outlet duct 43 preferably comprises a valve for selectively open and close the duct 43.

In order to enable a controlled distribution of steam, distribution means 41 are arranged at the base 49. Preferably, said distribution means 41 comprise a plurality of vertically and/or horizontally arranged apertures 42 provided at the circumference of the distribution means 41.

The steam generator 48 is connected to a liquid supply 45 by means of the liquid supply means 40. Thereby, the liquid supply 45 is removably connected to the support means 3 by a valve 46. The liquid supply 45 further comprises a lid 47 for filling liquid therein.

Preferably, the upper surface 3a of the support means 3 comprises a plurality of apertures or holes 47 such that moisture of liquid can be directed to a drip tray 50 located beneath said apertures or holes 47. The drip tray 50 is preferably removably arranged within the support 3.

According to the described embodiment, heating of a receptacle 2 is enabled due to hot steam or vapour to which the inner surface 2b of the receptacle 2 is subjected to.

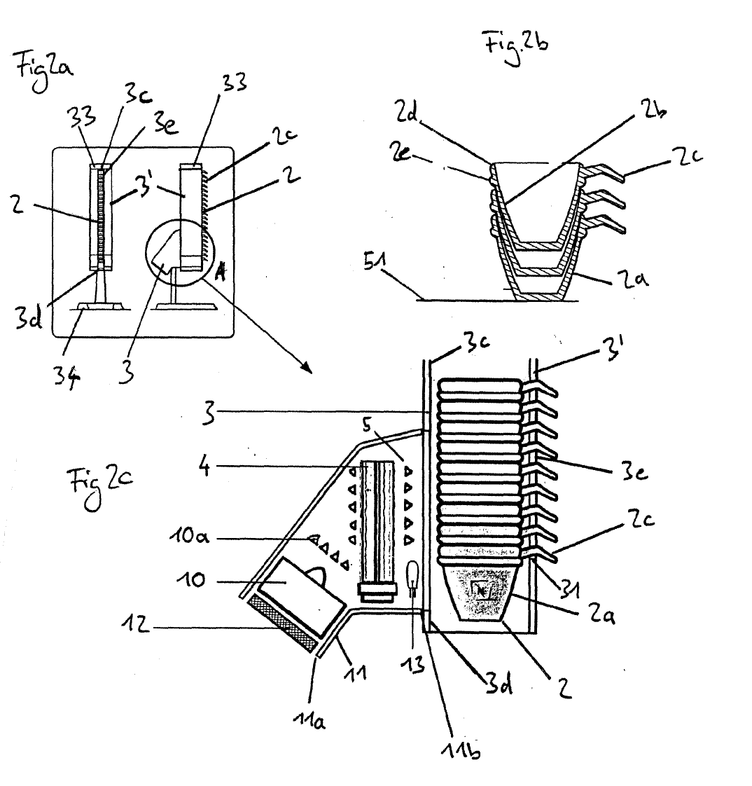

FIG. 2a shows a front and a side view of another preferred embodiment of the heating device according to the present invention. According to this embodiment, the support means 3 are designed to support a plurality of stacked receptacles 2 which are arranged above each other. Thereby, the heating means comprise a stand 34 connected to the support means 3 which enables a secure positioning of the device.

Moreover, the support 3 comprises a basically vertically arranged tubular member 3′ which is designed to house a plurality of stacked receptacles 2. Thereby, said tubular member 3′ comprises at one ending an upper aperture 3c for supplying receptacles to the tubular member 3′. Furthermore, the tubular member 3′ comprises at its lower ending a lower aperture 3d which enables a delivery of at least one receptacle from the tubular member 3′ to a human operator.

The tubular member 3′ additionally comprises a groove 3e at its lateral side portion through which the handles 2c of the receptacles 2 are protruding as can be seen in FIG. 2a.

The stacking of the receptacles 2 within the tubular member 3′ is obtained by stacking according to the method “first in first out”. Thereby, the number of receptacles 2 which can be housed within the tubular member 3′ depends on the dimensions of the tubular member 3′ in particular the height thereof. As can be seen in FIG. 2a, the tubular member 3′ may be provided with a lid 33 which can be opened such that receptacles 2 can be placed into the tubular member 3′. Accordingly, the lid 33 is preferably closed after providing the receptacles 2 to the tubular member 3′ such that the receptacles can be protected from dust or other dirt particles.

FIG. 2b shows a sectional side view of the stacked receptacles 2 to be used with the embodiment of the invention according to FIG. 2a.

As can be seen in FIG. 2b, the receptacles 2 comprise a bottom part of plane form to enable a safe positioning of the receptacle on a given surface 51. Moreover, the receptacles 2 comprise a handle portion 2c which is protruding from one side portion of the receptacle to a predefined extent. Thereby, the handle 2c is of kinked shape such that the handle 2c can be easily pinched between two fingers of a human operator and hence, a convenient handling of the receptacle 2 is enabled.

Furthermore, the receptacle 2 comprises below its upper rim portion 2d a circumferentially protruding bump 2e. Hence, when stacking the receptacles 2 as shown in FIG. 2b, the upper rim portion 2d of the lowermost receptacle 2 interacts with the circumferentially protruding bump 2e of another receptacle stacked thereto such that a convenient stacking of the receptacles 2 is enabled. Moreover, due to this arrangement, jamming of the stacked receptacles 2 can be prevented and the separation of the receptacles 2 is facilitated.

FIG. 2c shows a sectional side view of section A of the embodiment of the device according to the invention shown in FIG. 2a. As can be seen from the figure, the tubular portion 3′ of the support means 3 has an inner diameter which is slightly greater than the outer diameter of the receptacles 2. Hence, the tubular portion 3′ is designed such that the stacked receptacles 2 perfectly fit therein. Thereby, the kinked handles 2c of the receptacles 2 are protruding from a lateral side portion of the tubular member 3′ through a elongated slot 3e provided at the lateral surface of the tubular member 3′. Thereby, a lower edge 31 of said slot 2e interacts with the handle 2c of the lowermost receptacle 2 of the stacked receptacles in order to provide support for the stack of receptacles 2.

As shown in FIG. 2c, the device further comprises a heating component 4 and air generating means 10. Thereby, the heating component 4 is preferably arranged in vicinity to the tubular member 3′ such that heated air or radiating heat emitted by the heating component is transferred to the stack of receptacles 2.

The heating component 4 preferably comprises a cylindrical core portion made of mica which is surrounded by a metal wire. The metal wire is connected to a power supply such that electric current supplied to the wire can be transferred to radiation heat due to the resistance of the wire. Due to the cylindrical core portion made of mica, electric insulation of the wire is obtained. Moreover, since mica is very heat resistive, temperatures up to 600° are theoretically possible.

The air generating means 10 provided within the device are preferably arranged such that a stream of air 10a is produced in direction of the heat component 4. Moreover, air guiding means 11 are provided in which the air generating means 10 and the heat component 4 are disposed. Accordingly, due to this arrangement air 10a generated by the air generating means 10 is guided to heat component 4 and thus, heated air 5 is canalized and directed to the stack of receptacles 2. Therefore, the air guiding means comprise an aperture 11b which connects said air guiding means 11 and the tubular member 3′ in which the receptacles 2 are housed.

The air guiding means 11 further comprise an air inlet 11a which is preferably equipped with a filter means 12 and through which fresh air is sucked by the air generating means 10. Preferably, the air generating means 10 is a ventilator. However, it should be understood that any other means suitable for providing a stream of air to the heating component 4 may be used.

In a preferred embodiment, the device further comprises a temperature sensor 13 which is positioned in vicinity of the heating component 4 and which enables the monitoring of the temperature or radiating heat emitted by the heat component 4. Thereby, the temperature sensor 13 is preferably connected to a control unit (not shown) which deactivates the heating component 4 if the emitted radiating heat exceeds a predefined value. Preferably, the control unit regulates the operation of the heat component 4 such that a preferred target temperature between 45 and 55° C. in vicinity of the heat component 4 is obtained.

Due to the air guiding means 11 and the tubular member 3′ heated air which is provided by means of the air generating means 10 and the heating component 4 is effectively used to heat an outer surface of the stacked receptacles 2.

It should be understood that due to the conduction of the porcelain of which the receptacles 2 are made of, heating of a plurality of stacked receptacles 2 is possible although the radiating heat provided by the heat component does not directly hit the whole outer surface of the receptacles 2 at an upper portion of the stack.

The air guiding means 11 and the tubular portion 3′ are preferably made of or coated by an insulating material. Hence, energy or heat loss to the environment from the inside of the air guiding means 11 or the tubular member 3′ can be suppressed.

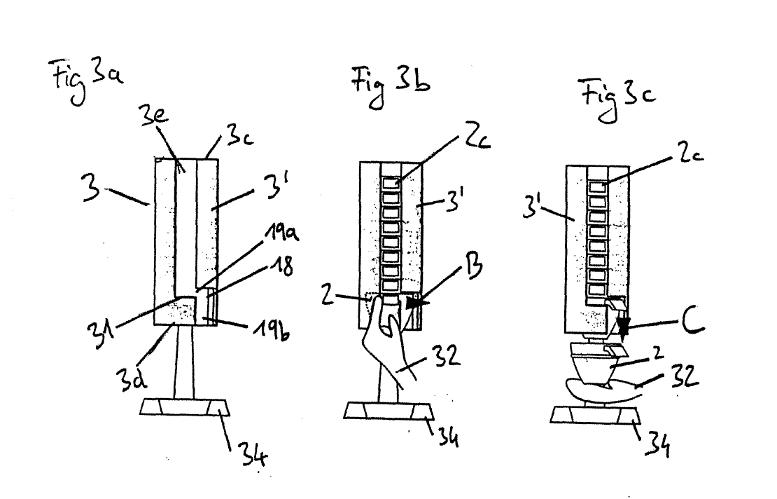

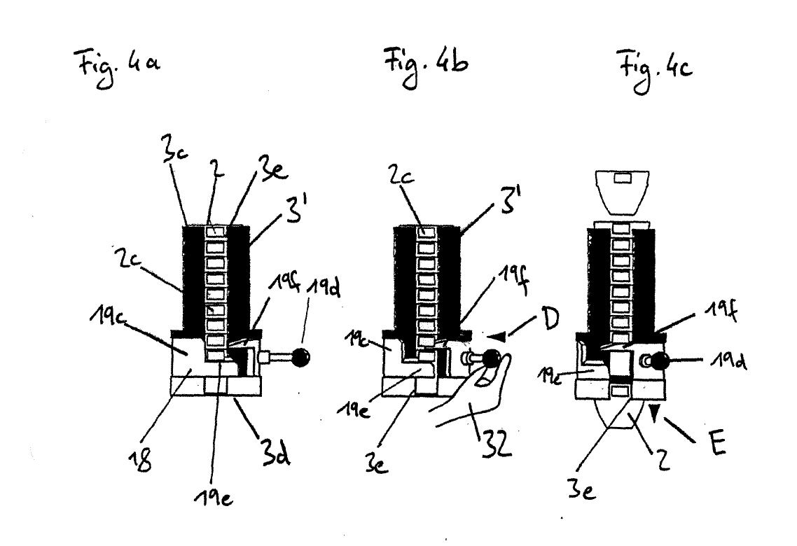

FIGS. 3a to 3c show a front view of the device according to the embodiment shown in FIGS. 2a and 2b, wherein the support means 3 comprise release means 18 for selectively releasing the stacked receptacles 2 from the tubular member 3′ of the support means 3.

As can be seen in FIG. 3a, the elongated slot 3e of the tubular member 3′ comprises a lower edge portion 31 which is connected to the release means 18. Thereby, the release means 18 comprise a vertically arranged slot 19b which is arranged in parallel to the elongated slot 3e of the tubular member 3′ and which is connected to said elongated slot 3a by means of an aperture 19a provided at the lateral surface of the tubular member 3′. The aperture 19a is preferably designed such that a human operator can slide one handle 2c of a receptacle 2 vertically from its stacked position as shown in FIG. 3b to a release position as shown in FIG. 3c (shown by arrow B).

According to this, the lowermost receptacle 2 of the stack can be separated from the other receptacles 2 and thus, the separated receptacle 2 can be release from the support 3 as it falls down into a hand 32 of a human operator as indicated by arrow C in FIG. 3c.

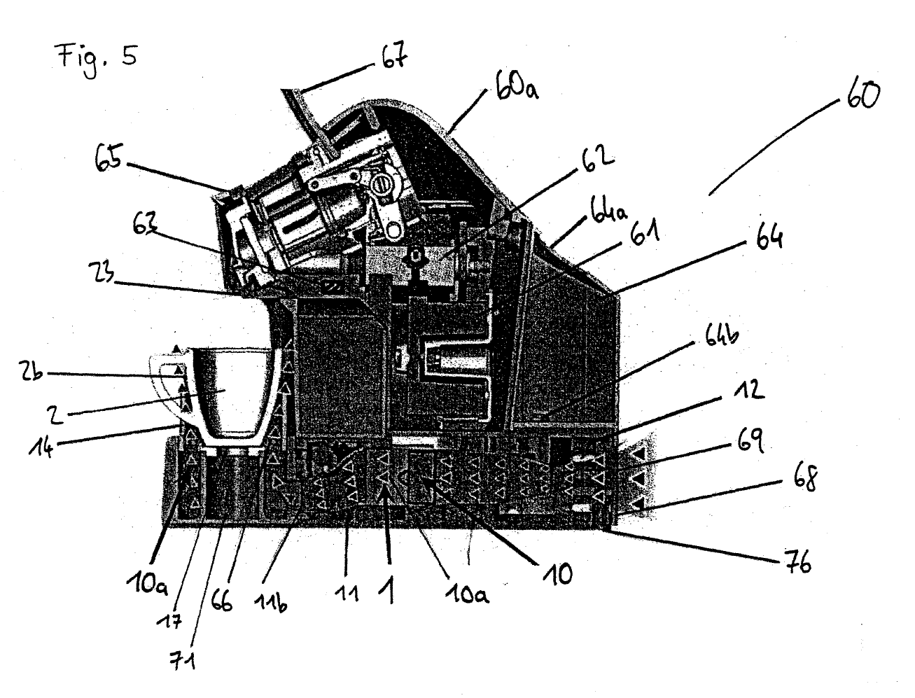

With respect to FIGS. 4a to 4c, another preferred embodiment of the release means 18′ is shown. Thereby, the tubular member 3′ is equipped at its lower end 3d with a mechanical release member 19c mounted at the lateral surface of the tubular member 3′. Said release member 19c is of rotationally mounted at the tubular member 3′ and can be selectively brought from a first holding position as shown in FIG. 4a to a second release position as shown in FIG. 4c.

The release member 19c comprises a support 19e which is a preferably rectangular aperture which gives support to the stacked receptacles 2 housed within the tubular member 3′. Thereby, the support 19e particularly interacts with the handle 2c of the lowermost receptacle 2 of the stack.

The release member 19c further comprises a wedge-shaped separating member 19f which can be selectively brought into a position to separate the handles 2c of the lowermost receptacle and the receptacle situated directly above it.

According to this, a human operator 32 can rotate the release means 18′ about the central axis thereof by means of the handle 19d provided at the release means 18′, as indicated by arrow D in FIG. 4b. Hence, the wedge-shaped separation member 19f separates the handles 2c of the lowermost two receptacles 2 in the stack. A further rotation of the release means 18′ results in the release of the lowermost receptacle 2 of the stack as shown in FIG. 4c.

It should be noted that any other separation or delivery means may be applied to the tubular member 3′ of the support 3 in order to enable a convenient delivery of a warm or hot receptacle from the stack. In particular, automated delivery means may be applied to the tubular member 3′ in order to enable an automated delivery by pressing a dedicated push-button for example.

Moreover, in order to facilitate the delivery of the receptacles 2, the tubular member 3′ may be equipped with bearings circumferentially arranged at its inner surface which enable a guiding of the stacked receptacles 2 within the tubular member 3′.

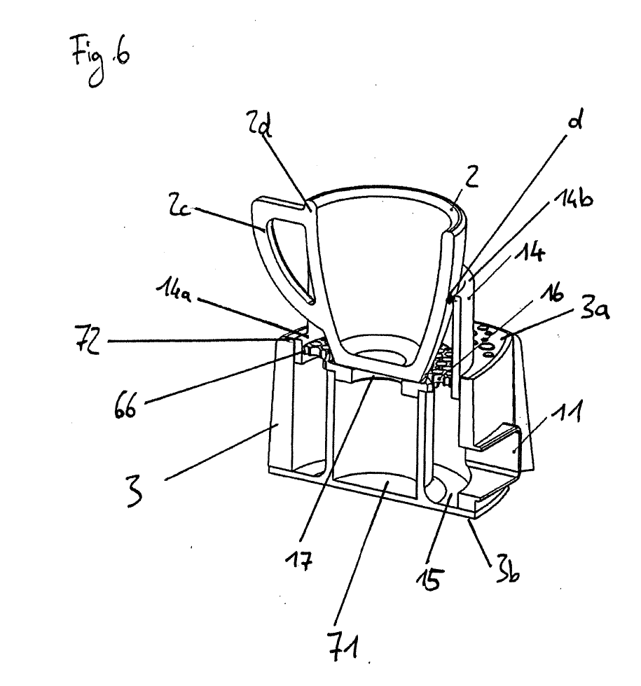

FIG. 5 shows a sectional side view of a preferred embodiment of a capsule based beverage production device 60 according to the present invention.

The device 60 comprises a housing 60a containing at least a boiler 61, a pump 62 and control means 63. Further the device comprises a liquid reservoir 64 connected to the device, an extraction head 65 and a base 76 which is preferably provided with feet for standing the device thereon in a stable manner. The device further comprises a support 3 for a receptacle 2 such as a cup having an upper surface 3a provided with a grill 66 on which the receptacle is positioned.

The reservoir 64 is provided in order to supply liquid such as water to the boiler 61 and the pump 62, and hence to the extraction head 65 and an injection member (not shown) of the device 60. Preferably, the reservoir 64 is connected to the device in a detachable manner and has an inlet 64a in order to insert liquid. An outlet 64b which is preferably situated at the bottom of the reservoir 64 enables a connection between the reservoir 64 and the device 60.

It should be understood that the term “pump” means any technical means that can transport a liquid at a sufficient positive pressure from the liquid reservoir 64 to the injection member within the extraction head 65. This means can be a pressure pump such as a piston pump, a diaphragm pump, a peristaltic pump, a gear pump, a centrifugal pump, a progressive cavity pump, a hand pump and the like.

The extraction head 65 of the device comprises a closing mechanism 67 for selectively enclosing a capsule, pad or pouch (not shown) provided to the device 60. When such a capsule is enclosed within the extraction head 65, an interaction between an injection member and the capsule is enabled during operation of the device such that heated pressurised liquid can be provided to the capsule in order to interact with portioned ingredients enclosed therein.

The internal pressure within the sealed capsule which is built up due to the liquid supply to the capsule causes a lower face of the capsule to open which enables the output of the beverage to be prepared through said lower face of the capsule and hence, through a delivery outlet 23 of the device 60. Thereby, the injection of the liquid provided by the device takes place at an upper face of the capsule which is pierced by the injection member of the device. As already described, the output of the beverage to be prepared takes place at the lower face of the capsule thus, enabling a direct flow of the liquid. Accordingly, the beverage to be prepared by the device 60 is delivered by means of a delivery outlet 23 provided above the support 3 of the receptacle 2. Hence, a receptacle 2 such as a cup can be placed beneath the delivery outlet 23 in order to receive the beverage to be prepared.

The present invention may as well apply to any other food or beverage cartridge, pod or sachet containing ingredient(s) brewed, dissolved or diluted in a beverage device according to other principles than the one described in WO 03/059778. In the context of the invention, the term “capsule” is used to encompass such cartridge, pod or sachet using these other brewing principles.

The device further comprises heating means 1 which are preferably located in a base portion 68 of the device 60. The heating means 1 comprise a heat component 4, a air generating means 10 and guiding means 11. Thereby, the air generating means 10 are designed to provide a stream of air 10a to the heating component 4. Hence, the heating component 4 is positioned downstream of the air generating means 10 within the device 60.

The air generating means 10 suck air from an aperture 69 provided at a side portion of the housing 60a of the device 60 which is preferably equipped with filter means 12. Then, the sucked air 10a is guided by means of the guiding means 11 which are designed for canalizing the stream of air 10a within the device 60.

The heating component 4 is provided within the air guiding means 11 such that hot air or radiating heat emitted by said heating component 4 is canalized by means of the provided stream of air 10a and the guiding means 11 to an outlet aperture 11b.

The heating component 4 may be any means for providing hot air or radiating heat to the vicinity thereof such as infrared sources, halogen lamps, or heating coils for example.

The outlet aperture 11b of the guiding means 11 is connected to the grill 66 which is provided at the upper surface 3a of the support 3 onto which the receptacle 2 is placed. Accordingly, heated air and/or radiating heat can be provided to the grill 66 and hence by means of apertures or holes 16 formed in the grill 6 to the inner and/or outer surface 2a,2b of the receptacle 2. Hence, effective heating of the receptacle 2 is obtained.

In a preferred embodiment, the control unit 63 of the device 60 is designed for controlling the heating means 1 such that the heating means 1 are operated prior to and/or during the beverage preparation. In particular, the heating means 1 are activated when a user intends to prepare a beverage with the device 60. Since the beverage extraction from the capsule takes several seconds, the blind time of the beverage preparation, i.e. the time in which the beverage extraction from the capsule takes place and in which no beverage is delivered to the receptacle 2 through the delivery outlet 23 of the device, can be effectively utilized for heating the receptacle 2 by means of the heating means 1.

Moreover, the heating means 1 may be activated by the control means 63 until the beverage preparation is finished and the entire beverage to be delivered by means of the delivery outlet 23 has been provided to the receptacle 2.

FIG. 6 shows a perspective sectional side view of the guiding means 11 and the retractable enclosing means 14 according to the present invention.

As shown in FIG. 6, the support 3 comprises a hollow ring portion 15 which is connected to the guiding means 11. The hollow ring portion 11 is covered by means of the grill 66 which comprises a plurality of apertures or holes 16. Hence, hot air or radiating heat which is provided by the guiding means 11 to the hollow ring portion 15 is guided through apertures 16 of the grill 66. According to this, an outer surface 2a of a receptacle 2 which is placed on the grill 66 can effectively be heated.

The apertures 16 of the grill 66 are preferably of round shape. However, the apertures 16 may be of different diameter in order to selectively provide different amounts of heat to different regions of the outer surface 2a of the receptacle 2.

The grill 66 further comprises a large aperture 17 at its centre portion which is connected to a drip tray 71 of the device 60. Hence, in case no receptacle 2 is placed on the support 3, remaining liquid which drops from the delivery outlet 23 of the device 60 (see FIG. 5) is collected by the drip tray 71.

In addition, the upper surface 3a of the support 3 comprises a circumferential edge portion 72 to which retractable enclosing means 14 can be connected.

The retractable enclosing means 14 is preferably of cylindrical shape and designed such that at least ½ or preferably ⅔ of the height of the receptacle are surrounded by said enclosing means 14. Thereby, the enclosing means 14 comprise a slot 14a through which the handle 2c of the receptacle 2 can protrude. Hence, the enclosing means 14 can be designed to tightly enclose the receptacle 2.

Preferably, the enclosing means 14 are designed such that an upper rim portion 14b is positioned at a predefined distance d to the outer surface 2a of the receptacle 2. Preferably, the distance d is 1-2 mm. According to this, hot air which is actively provided by the heating means 1 to the grill 66 and hence to the space between the enclosing means 14 and the outer surface 2a of the receptacle 2. Due to the small distance d between the upper rim portion 14b and the surface 2a of the receptacle 2 heat is trapped within the space between the enclosing means 14 and the receptacle 2. Thus, heat loss to the environment can be suppressed and heating of the receptacle 2 is enhanced.

Moreover, since the enclosing means 14 do not fully enclose the receptacle 2, selective heating of the outer surface 2a of the receptacle 2 is enabled. Hence, an upper rim portion 2d of the receptacle 2 is not fully heated and thus, a user is prevented from burning his or her lips when drinking from the receptacle 2 after the heating thereof.

The enclosing means 14 are preferably made of a conductive material such as a metal to further enhance the heating of the receptacle. Thereby, the enclosing means preferably comprise holding means (not shown) such that a human operator can handle the enclosing means 14 without burning his or her fingers.

Preferably, the enclosing means 14 are designed to be adjustable to different shapes and geometric dimensions of receptacles. Therefore, adjustment means (not shown) may be provided which enable the adjustment of the enclosing means 14. For example, enclosing means 14 of different thicknesses may be provided. Furthermore, additional inserts may be provided for the enclosing means 14 to enable the enclosing of variable receptacles 2.

Moreover, the enclosing means 14 may be of an elastic material such as rubber or the like which easily adopts the geometric form of the receptacle 2 and thus enhances the warming thereof.

Although the present invention has been described with reference to preferred embodiments thereof, many modifications and alternations may be made by a person having ordinary skill in the art without departing from the scope of this invention which is defined by the appended claims.

1.-15. (canceled)

16. A heating device for cup-shaped receptacles comprising support means for supporting a cup-shaped receptacle, with the support means comprising heating means designed to generate and guide heated air or radiating heat to the receptacle in order to heat a surface of the receptacle, with the surface to be heated including the whole inner or outer surface of the cup-shaped receptacle.

17. The heating device according to claim 16, wherein the heating means comprises a heating component integrated in the support means of the device which component is designed to provide the heat or radiating heat to the receptacle.

18. The heating device according to claim 17, wherein the heating component is connected to a switchable circuit which comprises detection means designed to enable a detection of a receptacle placed on the support means.

19. The heating device according to claim 18, wherein the switchable circuit is designed to activate the heating component for a predefined period of time when a receptacle is placed onto the support.

20. The heating device according to claim 19, wherein the device further comprises adjustment means for adjusting the period of time in which the heating component is activated.

21. The heating device according to claim 18, wherein the detection means and the switchable circuit are integrated in the support means of the device.

22. The heating device according to claim 17, wherein the heating means further comprises air generating means which are designed for providing a stream of air towards the heating component of the device.

23. The heating device according to claim 22, wherein the heating means further comprises guiding means for guiding the heated air or radiating heat towards the inner or outer surface of the receptacle.

24. The heating device according to claim 23, further comprising retractable enclosing means which can be connected to the guiding means and which are designed to selectively enclose a receptacle.

25. The heating device according to claim 24, wherein the retractable enclosing means comprise adjustment means in order to enable an enclosing of receptacles of variable dimensions.

26. The heating device according to claim 16, wherein the support means of the device are designed to support a plurality of stacked receptacles and wherein the support means comprises mechanical release means for selectively releasing at least one of the receptacles from the stack of receptacles.

27. The heating device according to claim 26, wherein the guiding means are designed such that at least one of the plurality of stacked receptacles is provided with the heated air or radiating heat.

28. The heating device according to claim 16, wherein the heating component is a halogen lamp.

29. A capsule based beverage production device for preparing a beverage from a food substance contained in a capsule by injection of a liquid into the capsule, wherein the liquid is provided by a pump, the device comprising:
a liquid supply which is in fluid connection with the pump,
a control unit for controlling at least the pump of the device,
a support for placing a receptacle thereon, wherein the support is arranged below a liquid outlet of the device,
heating means designed to provide heated air or radiating heat to an inner or outer surface of a receptacle placed on the support of the device.

30. The beverage production device according to claim 29, wherein the control unit of the device is designed for controlling the heating means of the device such that the heating means are operated prior to and during the beverage preparation.
